(19) United States
(12) Patent Application Publication
(10) Pub. No.: US 2016/0028259 A1
(43) Pub. Date: Jan. 28, 2016

(54) Portable Charging Assembly

(71) Applicant: Mack Anderson, Kileen, TX (US)

(72) Inventor: Mack Anderson, Kileen, TX (US)

(21) Appl. No.: 14/341,170

(22) Filed: Jul. 25, 2014

(51) Int. Cl. H02J 7/00; H02J 7/35

(52) U.S. Cl. CPC H02J 7/0042; H02J 7/35

(57) ABSTRACT

A portable charging assembly includes a housing. A lever is movably coupled to the housing. The lever may be depressed. A generator is coupled to the housing. A drive gear is movably coupled to the housing. The drive gear is movably coupled to the generator. The lever engages the drive gear when the lever is depressed. The drive gear moves the generator. The generator produces an electrical current when the lever is depressed. A battery is coupled to the housing. The battery is operationally coupled to the generator. The battery is charged by the generator. A pair of power ports is coupled to the housing. The power ports are operationally coupled to the battery. The power ports are selectively operationally coupled to an external electronic device. The battery charges the external electronic device.

### BACKGROUND OF THE DISCLOSURE

### Field of the Disclosure

The disclosure relates to charging devices and more particularly pertains to a new charging device for charging an external electrical device in a remote location.

### SUMMARY OF THE DISCLOSURE

An embodiment of the disclosure meets the needs presented above by generally comprising a housing. A lever is movably coupled to the housing. The lever may be depressed. A generator is coupled to the housing. A drive gear is movably coupled to the housing. The drive gear is movably coupled to the generator. The lever engages the drive gear when the lever is depressed. The drive gear moves the generator. The generator produces an electrical current when the lever is depressed. A battery is coupled to the housing. The battery is operationally coupled to the generator. The battery is charged by the generator. A pair of power ports is coupled to the housing. The power ports are operationally coupled to the battery. The power ports are selectively operationally coupled to an external electronic device. The battery charges the external electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a portable charging assembly according to an embodiment of the disclosure.

FIG. 2 is a back view of an embodiment of the disclosure.

FIG. 3 is a front view of an embodiment of the disclosure.

FIG. 4 is a right side view of an embodiment of the disclosure.

FIG. 5 is a top view of an embodiment of the disclosure.

FIG. 6 is a bottom view of an embodiment of the disclosure.

### DESCRIPTION OF THE PREFERRED EMBODIMENT

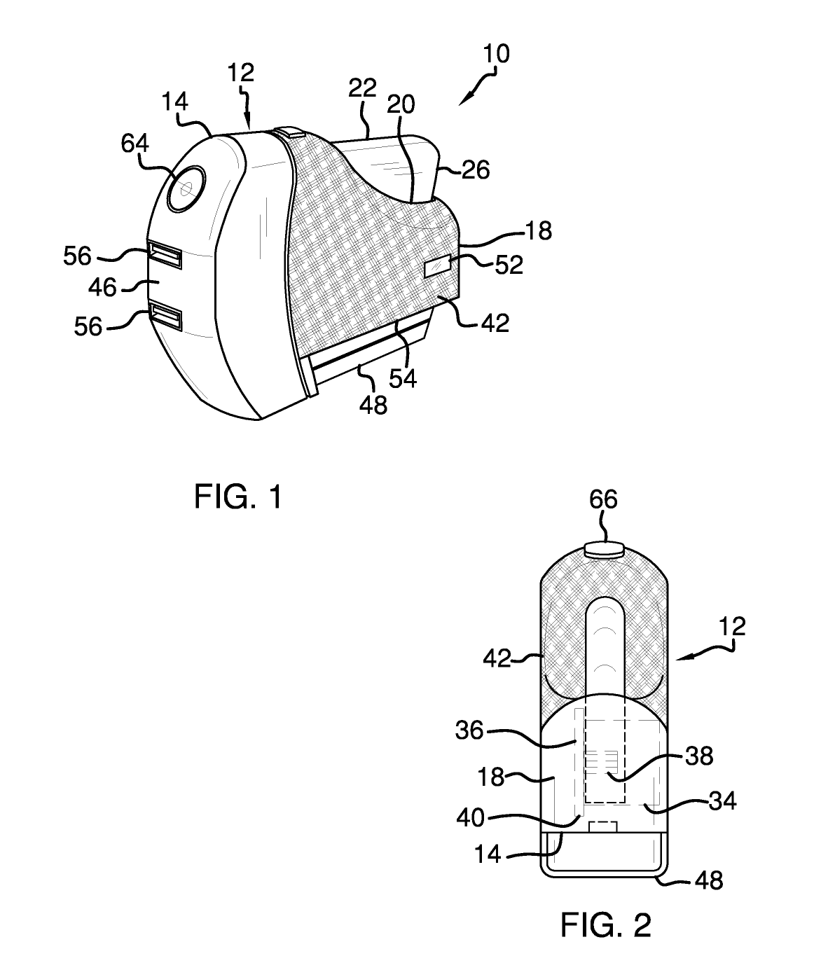

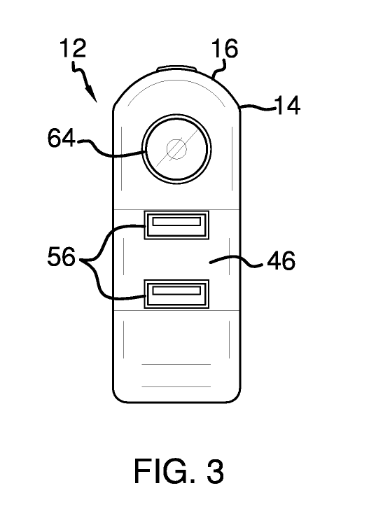

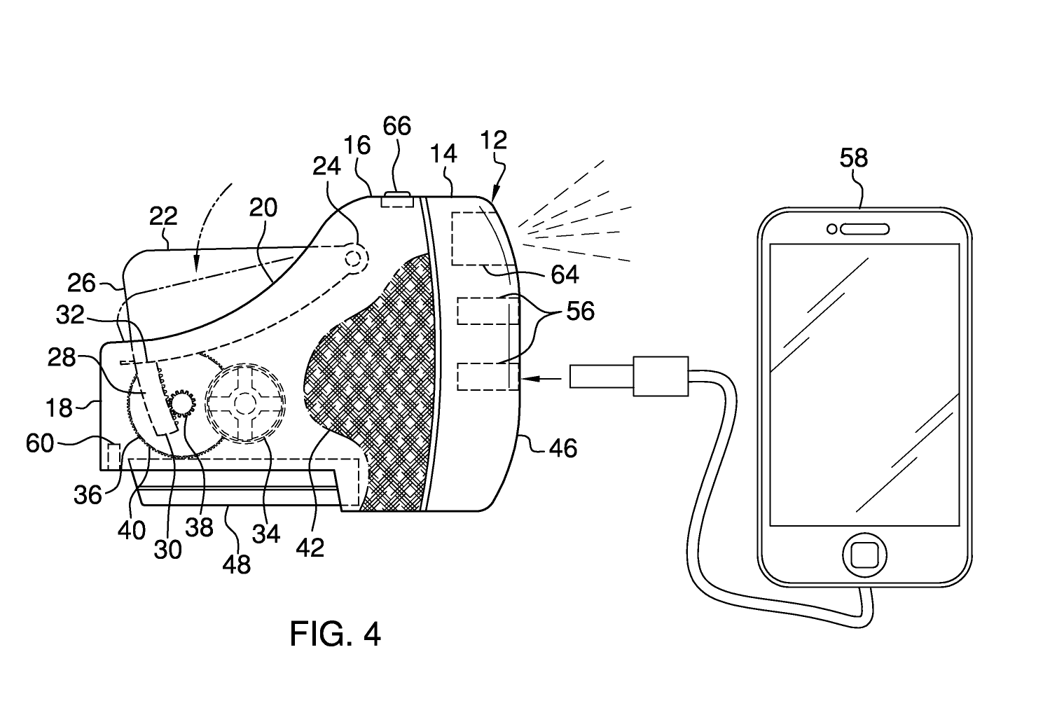

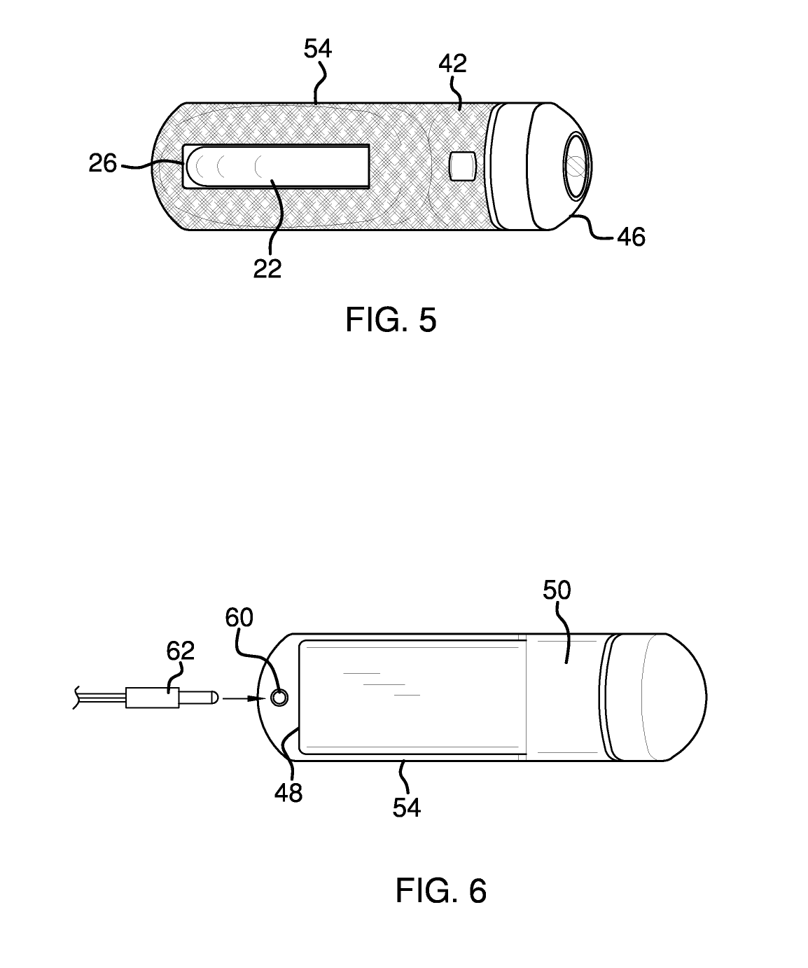

With reference now to the drawings, and in particular to FIGS. 1 through 6 thereof, a new charging device embodying the principles and concepts of an embodiment of the disclosure and generally designated by the reference numeral 10 will be described.

As best illustrated in FIGS. 1 through 6, the portable charging assembly 10 generally comprises a housing 12. The housing 12 an outer wall 14. A top side 16 of the outer wall 14 of the housing 12 curves downwardly proximate a back side 18 of the outer wall 14 of the housing 12 to define a curved portion 20 of the top side 16 of the outer wall 14 of the housing 12. Additionally, the curved portion 20 of the top side 16 of the outer wall 14 of the housing 12 is open.

A lever 22 is provided. The lever 22 has a front end 24 and a back end 26. The front end 24 of the lever 22 is hingedly coupled to the top side 16 of the outer wall 14 of the housing 12. Moreover, the lever 22 is positioned in the open top side 16 of outer wall 14 of the housing 12. The back end 26 of the lever 22 may be urged downwardly into the housing 12.

A rail gear 28 has a free end 30 and a coupled end 32. The coupled end 32 of the rail gear 28 is coupled to the back end 26 of the lever 22. The rail gear 28 extends downwardly from the lever 22 into the housing 12. A generator 34 is coupled to the housing 12. The generator 34 is positioned within an interior of the housing 12. The generator 34 may be an electromagnetic generator of any conventional design.

A drive gear 36 is provided. The drive gear 36 comprises a primary portion 38 of the drive gear 36 extending laterally away from a secondary portion 40 of the drive gear 36. The primary portion 38 of the drive gear 36 has a diameter that is less than a diameter of the secondary portion 40 of the drive gear 36.

The drive gear 36 is rotatably coupled to the housing 12. Moreover, the drive gear 36 is positioned within an interior of the housing 12. The secondary portion 40 of the drive gear 36 engages the generator 34.

The rail gear 28 engages the primary portion 38 of the drive gear 36. The rail gear 28 rotates the drive gear 36 when the back end 26 of the lever 22 is depressed. Additionally, the drive gear 36 rotates the generator 34 so the generator 34 produces an electrical current.

A photovoltaic skin 42 is wrapped around the outer wall 14 of the housing 12. The photovoltaic skin 42 extends from the back side 18 of the outer wall 14 of the housing 12 toward a front side 46 of the outer wall 14 of the housing 12. The photovoltaic skin 42 may absorb solar energy. Moreover, the photovoltaic skin 42 produces an electrical current.

A battery 48 is removably coupled to a bottom side 50 of the outer wall 14 of the housing 12. The battery 48 is electrically coupled to the generator 34 and the photovoltaic skin 42. The battery 48 is charged by the generator 34 and the photovoltaic skin 42. Additionally, the battery 48 may be a Lithium Ion battery of any conventional design. A charge indicator 52 is coupled to a first lateral side 54 of the outer wall 14 of the housing 12. The charge indicator 52 is electrically coupled to the battery 48. The charge indicator 52 displays a level of charge in the battery 48.

A pair of power ports 56 is coupled to the front side 46 of the outer wall 14 of the housing 12. The power ports 56 are electrically coupled to the battery 48. The power ports 56 are selectively electrically coupled to an external electronic device 58 so the battery 48 charges the external electronic device 58. The external electronic device 58 may be a smart phone or other similar external electronic device 58. Additionally, the power ports 56 may be USB ports of any conventional design.

An input port 60 is coupled to the bottom side 50 of the outer wall 14 of the housing 12. The input port 60 is electrically coupled to the battery 48. The input port 60 may be electrically coupled to a power source 62 so the input port 60 charges the battery 48. The power source 62 may be a battery charger of any conventional design.

A light emitter 64 is coupled to the front side 46 of the outer wall 14 of the housing 12. An actuator 66 is coupled to the top side 16 of the outer wall 14 of the housing 12. The actuator 66 is electrically coupled between the battery 48 and the light emitter 64. The light emitter 64 emits light when the actuator 66 is actuated.

In use, the assembly 10 is used to charge the external electronic device 58 when the power source 62 is not available. The lever 22 is depressed multiple times to recharge the battery 48 after the battery 48 is depleted. The external electronic device 58 may be charged multiple times.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A portable charging assembly comprising:
a housing;
a lever movably coupled to said housing such that said lever is configured to be depressed;
a generator coupled to said housing;
a drive gear movably coupled to said housing, said drive gear being movably coupled to said generator, said lever engaging said drive gear when said lever is depressed such that said drive gear moves said generator, said generator producing an electrical current when said lever is depressed;
a battery coupled to said housing, said battery being operationally coupled to said generator such that said battery is charged by said generator;
a pair of power ports coupled to said housing, said power ports being operationally coupled to said battery, said power ports being selectively operationally coupled to an external electronic device such that said battery charges the external electronic device; and
a photovoltaic skin wrapped around an outer wall of said housing such that said photovoltaic skin is configured to absorb solar energy.

2. The portable charging assembly according to claim 1, further comprising said lever having a front end and a back end, said front end of said lever being hingedly coupled to said housing such that said back end of said lever is configured to be urged downwardly toward said housing.

3. The portable charging assembly according to claim 2, further comprising a rail gear having a free end and a coupled end, said coupled end of said rail gear being coupled to said back end of said lever such that said rail gear extends downwardly from said lever into said housing.

4. The portable charging assembly according to claim 1, further comprising said drive gear comprising a primary portion of said drive gear extending laterally away from a secondary portion of said drive gear.

5. The portable charging assembly according to claim 4, further comprising said drive gear being rotatably coupled to said housing such that said drive gear is positioned within an interior of said housing, said secondary portion of said drive gear engaging said generator.

6. The portable charging assembly according to claim 5, further comprising a rail gear engaging said primary portion of said drive gear, said rail gear rotating said drive gear when a back end of said lever is depressed such that said drive gear rotates said generator.

7. The portable charging assembly according to claim 1, further comprising said battery being electrically coupled to said generator.

8. The portable charging assembly according to claim 1, further comprising said power ports being electrically coupled to said battery, said power ports being selectively electrically coupled to the external electronic device.

9. (canceled)

10. The portable charging assembly according to claim 1, further comprising said photovoltaic skin being electrically coupled to said battery, said photovoltaic skin producing an electrical current such that said photovoltaic skin charges said battery.

11. A portable charging assembly comprising:
a housing;
a lever having a front end and a back end, said front end of said lever being hingedly coupled to said housing such that said back end of said lever is configured to be urged downwardly toward said housing;
a rail gear having a free end and a coupled end, said coupled end of said rail gear being coupled to said back end of said lever such that said rail gear extends downwardly from said lever into said housing;
a generator coupled to said housing;
a drive gear comprising a primary portion of said drive gear extending laterally away from a secondary portion of said drive gear, said drive gear being rotatably coupled to said housing such that said drive gear is positioned within an interior of said housing, said secondary portion of said drive gear engaging said generator;
said rail gear engaging said primary portion of said drive gear, said rail gear rotating said drive gear when said back end of said lever is depressed such that said drive gear rotates said generator wherein said generator produces an electrical current;
a photovoltaic skin wrapped around an outer wall of said housing such that said photovoltaic skin is configured to absorb solar energy wherein said photovoltaic skin produces an electrical current, said photovoltaic skin extending from a back side of said housing toward a front side of said housing and being positioned on opposite outer faces of said housing;
a battery coupled to said housing, said battery being electrically coupled to said generator and said photovoltaic skin such that said battery is charged by said generator and said photovoltaic skin; and
a pair of power ports coupled to said housing, said power ports being electrically coupled to said battery, said power ports being selectively electrically coupled to an external electronic device such that said battery charges the external electronic device.
